(19) United States
(12) Patent Application Publication
(10) Pub. No.: US 2009/0227308 A1
(43) Pub. Date: Sep. 10, 2009

(54) Gaming Machine

(75) Inventor: Kazumasa YOSHIZAWA, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Tokyo (JP)

(21) Appl. No.: 12/398,604

(22) Filed: Mar. 5, 2009

Related U.S. Application Data
(60) Provisional application No. 61/034,380, filed on Mar. 6, 2008.

(51) Int. Cl. A63F 9/24; A63F 13/00

(52) U.S. Cl. 463/12; 463/30

(57) ABSTRACT

A gaming machine according to the present embodiment, one or a plurality of lucky numbers are set in a one game unit or a plurality of games unit based on a player's operation prior to the start of the game. Then, if it is judged that the total value of the numbers on the two cards which were initially dealt to the player equals the lucky numbers, a selection as to whether to place an additional bet is displayed on the liquid crystal display. If the player has selected to place an additional bet, a processor accepts the additional bet operation. And a processor awards to the player a prize based on the total bet amount obtained by adding the additional bet amount to the bet amount on which a bet was placed before the start of the game.

### CROSS-REFERENCE TO RELATED APPLICATIONS

This application is based upon and claims a priority from the U.S. provisional Patent Application No. 61/034380 filed on Mar. 6, 2008, the entire contents thereof are incorporated herein by reference.

### BACKGROUND

1. Technical Field

The gaming machine according to one or more aspects of the present invention relates to a gaming machine that advances a card game based on a card displayed on a display and input information from a player.

2. Description of Related Art

Conventionally, card game machines and tables have been installed in a casino or a game center or the like. These card game machines carry out card games such as Pai Gow Poker, Draw poker and Blackjack. Here, in such a card game, a game progresses by use of a card having a suit and a number (for instance, heart and A). The contents of a prize that will be awarded to the player are decided based on a hand with the cards that were dealt to the player and the hand with the cards that were dealt to the dealer.

The contents of the prize that will be awarded to the player further vary depending on the amount of gaming values (hereinafter referred to as bet amount) bet by the player. Specifically, if the player bets a large amount of gaming values, the prize to be awarded reaches a high value even in the case a condition for the same prize has been met.

Accordingly, the bet amount is a significant parameter which largely influences the results of the game. Therefore, setting of the bet amount is an important decision to be made by the player. This bet amount is basically set by the player's operation before the game starts. Conventionally, the player could also change the bet amount during the progress of the game, like in “Raise” in the case of Poker, or “Double Down” in the case of Blackjack. However, conventionally, no special conditions were set for the operation to change the bet amount. Further, the player cannot select the conditions for the operation to change the bet amount.

The object of the present invention is to provide a gaming machine which can execute a game having entertainment characteristics which do not exist in the above-described conventional art, by accepting an additional bet operation if a card combination displayed on a display equals a predetermined combination selected by the player in advance.

### SUMMARY

Therefore, in order to achieve the object, according to a gaming machine of the present invention encompassing one or more aspects thereof, there is provided a gaming machine. The gaming machine comprises a display that displays a plurality of cards; an operation portion that accepts input information from a player; a bet operation portion that enables input of a player's bet operation for a player's entry to a game; and a processor. The processor causes the player to select one or a plurality of card combinations based on operation of the operation portion. The processor accepts the player's bet operation based on operation of the bet operation portion. The processor displays a predetermined number of cards dealt to the player on the display. The processor accepts an additional bet operation if a card combination displayed on the display equals a card combination selected by the player. As a result, the above gaming machine judges whether the right to place an additional bet should be awarded based on the card combination formed in the cards dealt to the player and the card combination selected by the player in advance. Accordingly, this makes it possible to set new conditions for placing an additional bet, thereby offering new attraction to the player.

According to the present invention encompassing one or more aspects, there is provided a gaming machine. The gaming machine comprises a display that displays a plurality of cards, each card having a number associated therewith; an operation portion that accepts an input operation from a player; a bet operation portion that enables input of a player's bet operation for a player's entry to a game; and a processor. The processor causes the player to select one or a plurality of numerical values based on operation of the operation portion. The processor accepts a player's bet operation based on operation of the bet operation portion. The processor displays a predetermined number of cards that were dealt to the player on the display. The processor accepts an additional bet operation if a total value of numbers associated with the cards displayed on the display equals a numerical value selected by the player. As a result, the above gaming machine judges whether the right to place an additional bet should be awarded based on the total of numbers associated with the cards dealt to the player and the numerical values that were selected by the player in advance. Accordingly, this makes it possible to set new conditions for placing an additional bet, thereby offering new attraction to the player.

According to the present invention encompassing one or more aspects, there is provided a gaming machine. The gaming machine comprises a display that displays a plurality of cards, each having a number associated therewith; an operation portion that accepts input information from a player; a bet operation portion that enables input of a player's bet operation for the player's entry to a game; and a processor. The processor causes the player to select one or a plurality of numerical numbers based on operation of the operation portion before the game starts. The processor accepts the player's bet operation based on an operation of the bet operation portion. The processor displays a predetermined number of cards that were dealt to the player on the display. The processor accepts an additional bet operation if a total value of numbers associated with the cards displayed on the display equals a numerical value selected by the player. As a result, the above gaming machine judges whether the right to place an additional bet should be awarded based on the total of numbers associated with the cards dealt to the player and the numerical values that were selected by the player in advance. Accordingly, this makes it possible to set new conditions for placing an additional bet, thereby offering new attraction to the player.

### BRIEF DESCRIPTION OF THE DRAWINGS

The accompanying drawings, which are incorporated in and constitute a part of this specification illustrate embodiments of the invention and, together with the description, serve to explain the objects, advantages and principles of the invention.

FIG. 1 is a view showing a bet screen which is displayed on a liquid crystal display in a player's terminal according to one embodiment of the present invention;

FIG. 2 is an external view of a gaming machine according to one embodiment of the present invention;

FIG. 3 is an external view of a player's terminal according to one embodiment of the present invention;

FIG. 4 is an explanatory view showing a control system of a gaming machine according to one embodiment of the present invention;

FIG. 5 is an explanatory view concerning a control system of a player's terminal according to one embodiment of the present invention;

FIG. 6 is a view showing a bet screen which is displayed on a liquid crystal display in a player's terminal according to one embodiment of the present invention;

FIG. 7 is a view showing a main screen which is displayed on the front display according to one embodiment of the present invention;

FIG. 8 is a flowchart of a game process program according to one embodiment of the present invention;

FIG. 9 is a flowchart of a game process program according to one embodiment of the present invention;

FIG. 10 is an example of a lucky number setting process which is executed by a gaming machine according to one embodiment of the present invention;

FIG. 11 is a view showing the maximum gaming value on which an additional bet can be placed in a gaming machine according to one embodiment of the present invention;

FIG. 12 is an example of a gaming table applied to the present invention.

### DETAILED DESCRIPTION

The various aspects summarized previously may be embodied in various forms. The following description shows by way of illustration of various combinations and configurations in which the aspects may be practiced. It is understood that the described aspects and/or embodiments are merely examples, and that other aspects and/or embodiments may be utilized and structural and functional modifications may be made, without departing from the scope of the present disclosure.

It is noted that various connections are set forth between items in the following description. It is noted that these connections in general and, unless specified otherwise, may be direct or indirect and that this specification is not intended to be limiting in this respect.

A gaming machine, a server, and a game system according to one or more aspects of the invention will be described in detail with reference to the drawings based on an embodiment embodying one or more aspects of the invention. However, it is appreciated that one or more aspects of the present invention may be embodied in distributable (via CD and the like) or downloadable software games, console games, and the like. In this regard, the slot machine may be a virtual slot machine that is displayed on a multi-purpose computer and/or dedicated kiosk. Aspects of the invention are described by way of hardware elements. However, it is appreciated that these elements may also be software modules that are executable in a computer. The software modules may be stored on a computer readable medium, including but not limited to a USB drive, CD, DVD, computer-readable memory, tape, diskette, floppy disk, and the like. For instance, aspects of the invention may be embodied in a JAVA-based application or the like that runs in a processor or processors. Further, the terms “CPU”, “processor”, and “controller” are inclusive by nature, including at least one of hardware, software, or firmware. These terms may include a portion of a processing unit in a computer (for instance, in multiple core processing units), multiple cores, a functional processor (as running virtually on at least one of processor or server, which may be local or remote). Further, in network-based gaming systems, the processor may include only a local processor, only a remote server, or a combination of a local processor and a remote server.

It is contemplated that one or more aspects of the invention may be implemented as computer executable instructions on a computer readable medium such as a non-volatile memory, a magnetic or optical disc. Further, one or more aspects of the invention may be implemented with a carrier signal in the form of, for instance, an audio-frequency, radio-frequency, or optical carrier wave.

Next, a detailed description will be given on embodiments relating to a gaming machine according to the present invention, while referring to the accompanying drawings. Here, the gaming machine according to the present embodiment is one type of a gaming machine that allows entry of a plurality of players. This player thus has a plurality of player's terminals and executes a Blackjack game which is one example of a card game. In Blackjack, each player first bets chips of a predetermined value. A winning condition is satisfied when the total value of the numbers on the cards dealt to the player is closer to “21” than the total value of the numbers on the cards dealt to the dealer, and a payout is made in accordance with the bet amount.

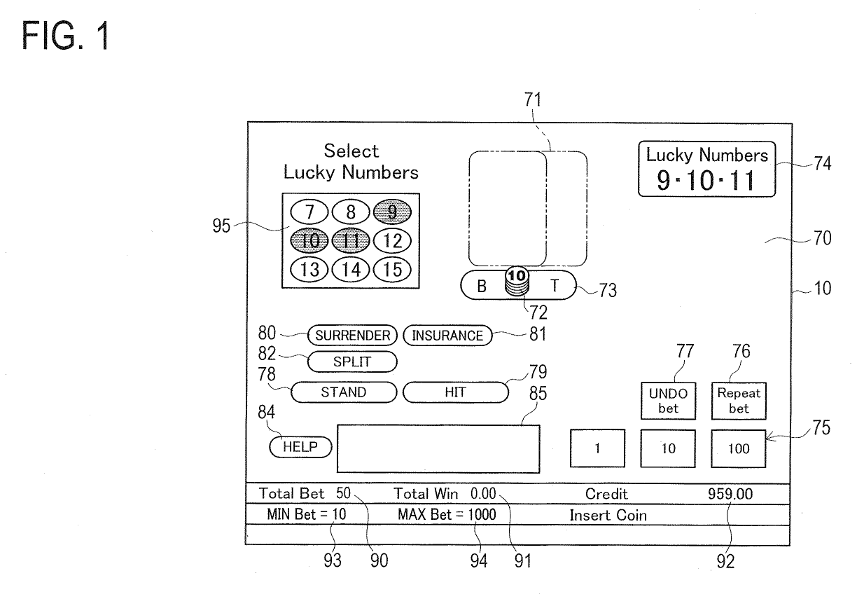

As shown in FIG. 1, in particular, in the gaming machine 1 according to the present invention, the player selects a plurality of numerical values (in the example shown in FIG. 1, “9”, “10” and “11”) before the game starts. If the total value of the numbers on the two cards that were initially dealt to the player equals the numerical value selected by the user, the right to place an additional bet by doubling down is granted to the player. Once the right to place an additional bet has been granted, a selection as to whether to double down will be displayed on the display. If the player selects to double down, an additional bet can be placed with the bet amount bet at present as the maximum amount.

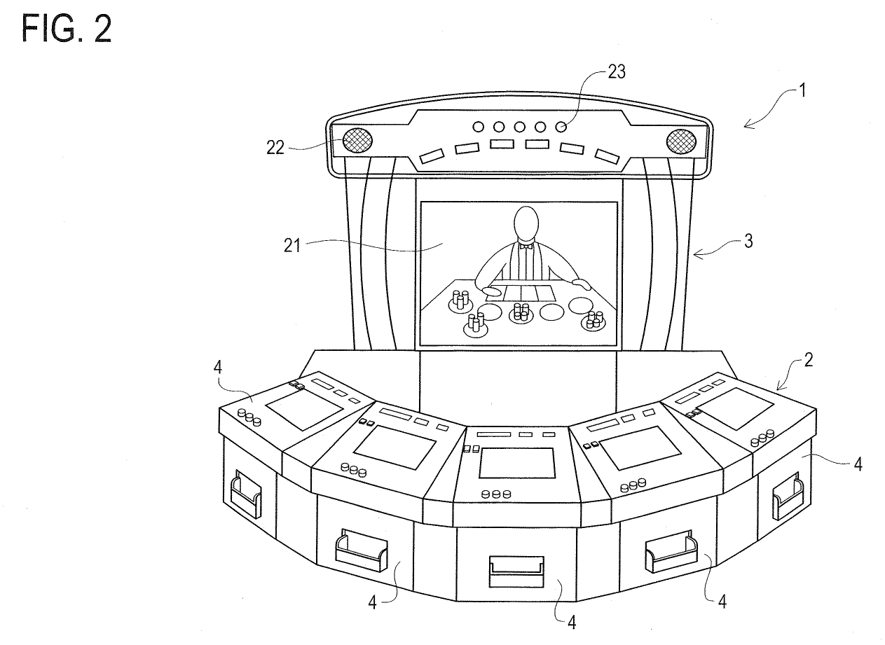

First, a schematic configuration of the gaming machine 1 according to the present embodiment will now be described based on FIG. 2. FIG. 2 is a view showing an outer appearance of the gaming machine 1 according to the present embodiment.

The gaming machine 1 according to the present embodiment is basically composed of a table portion 2 at which the players are seated to play a game, and a panel portion which is installed behind the table portion 2 and is adapted to display an animated image and the like of a dealer.

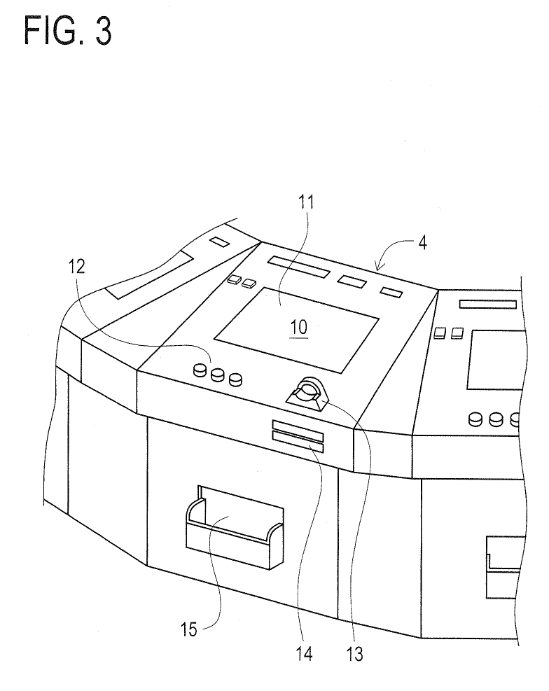

Next, the table portion 2 will be described first. The table portion 2 has a plurality of player's terminals 4 (in FIG. 2, five terminals) arranged in a fan-like fashion. These player's terminals are referred to as satellites. FIG. 3 is a view showing an outer appearance of one player's terminal 4 according to the present embodiment.

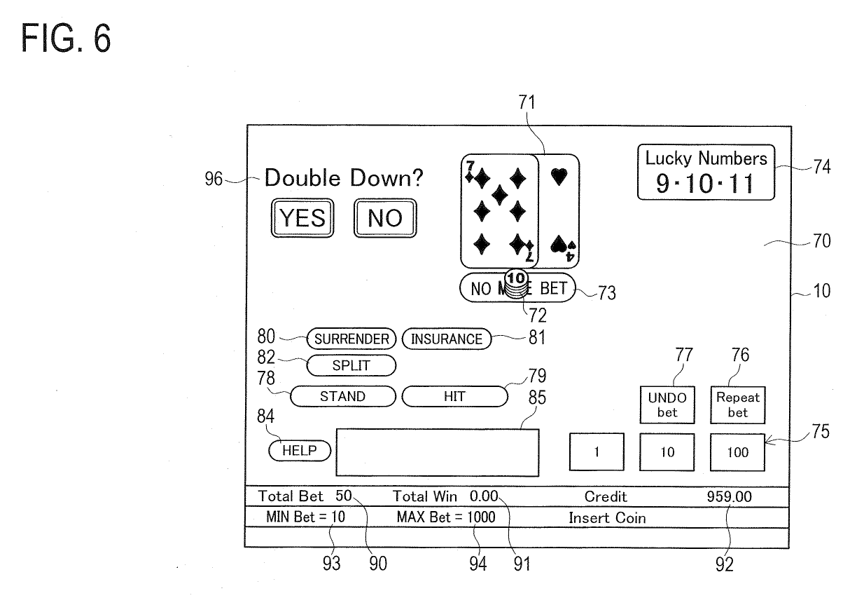

As shown in FIG. 3, the player's terminal 4 has a liquid crystal display 10, a touch panel 11, an operation button 12, a coin insertion slot 13, a bill insertion slot 14 and a coin payout port 15. The liquid crystal display 10 displays a bet screen that will be described later (refer to FIG. 1 and FIG. 6) and the results of the game or the like. The touch panel 11 is arranged at a front face of the liquid crystal display 10 and is employed in selecting a button which is displayed on the liquid crystal display 10 at the time of selecting the object of the bet and setting the bet amount. The operation button 12 carries out a payout operation and the like. The coin insertion slot 13 is employed to insert coins or medals, and the bill insertion slot 14 is employed to insert bills. The coin payout port 15 is employed at the time of a payout operation to pay out to the player an amount of coins or medals corresponding to an accumulated credit.

As shown in FIG. 2, the panel portion 3 consists of a front display 21, a speaker 22 and a LED 23. The front display 21 displays the image of the dealer that deals the cards and transfers chips and the contents of the cards that were dealt. The speaker is arranged at an upper portion of the front display 21 and is adapted to output music and sound effects in accordance with the progress of the game. The LED 23 lights up during execution of various effects.

Here, the cards to be used in the gaming machine 1 according to the present embodiment are the tramp cards which are generally employed, and display a “mark” consisting of a “suit” and “number” (refer to FIG. 6).

Here, “suit” refers to the mark of a tramp card and includes the spade, heart, diamond and club.

The “number” refers to the number or alphabetical character on the tramp cards and includes A (Ace, corresponding to 1), 2, 3, 4, 5, 6, 7, 8, 9, 10, J (Jack, corresponding to 11), Q (Queen, corresponding to 12) and K (King, corresponding to 13).

The “mark” refers to the card's type which is decided based on the combination of the “suit” and “number” of the tramp card, and includes, for instance, “A of hearts”, “K of spades” and the like.

Next, a playing method in the gaming machine 1 having the above-described configuration will not be described. The player that will play the game sits in front of the player's terminal 4 and places a bet of a desired bet amount by using the bet screen which is displayed on the liquid crystal display 10. The player selects the lucky numbers from a plurality of numerical values in a one game unit or a plurality of games unit. Then, images of the cards which were respectively dealt to the player and the dealer are displayed on the front display 21 and each liquid crystal display 10. If the total of the numbers on the two cards that were initially dealt to the player equals any of the lucky numbers that the player wants to select, a right to place an additional bet by doubling down is granted. Then, an effect image showing that either of the player and the dealer becomes the winner or an effect image showing a draw is displayed from the type of the dealt cards. Further, if the player has won to the dealer at each player's terminal 4, he/she is awarded a credit twice the bet amount (credit amount) that was bet, as prize. Alternatively, if the player loses to the dealer, he/she is not awarded a prize. Further, in case of a draw with the dealer, the credit corresponding to the bet amount that was bet is refunded to the player.

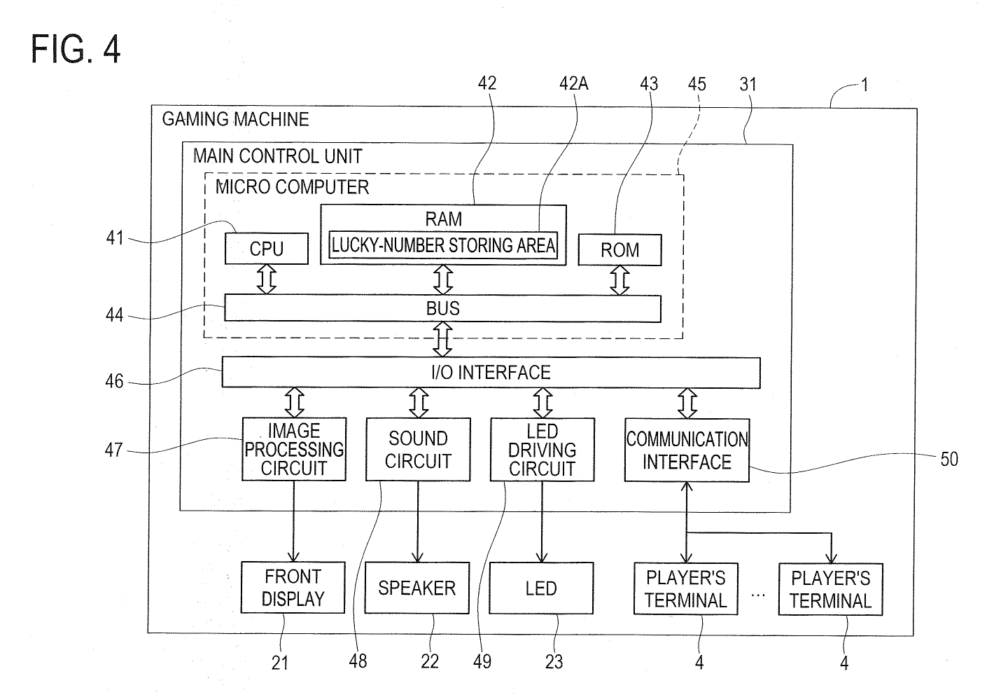

A configuration of a control system in a gaming machine 1 will next be described based on FIG. 4. FIG. 4 is a block diagram schematically showing the control system in the gaming machine 1 according to the present embodiment. The gaming machine 1 according to the present embodiment is constituted of a main control portion 31, a plurality of player's terminals 4 connected to the main control portion 31 and a variety pf peripheral devices.

The main control portion 31 is basically constituted around a microcomputer 45 which in turn is constituted of a CPU 41, a RAM 42, a ROM 43 and a bus 44 for data transfer amongst these components. Data tables and a variety of programs for carrying out processes required for the control in the gaming machine 1 are stored in the ROM 43. The RAM 42 serves to temporarily store a variety of data which is computed in the CPU 41. Further, a lucky number storing area 42A is provided in the RAM 42 to store the lucky numbers which are currently set in each player's terminal 4.

The CPU 41 is connected to an image processing circuit 47, a sound circuit 48, an LED driving circuit 49 and a communication interface 50 through the I/O interface 46.

The main control portion 31 receives information on the player's bet operation such as the bet amount or the like from each player's terminal 4 and judges whether a game start condition is met. Once the game starts, a predetermined number of cards (at least two cards) from a total of 52 tramp cards are respectively handed out to the player and the dealer based on the lottery results (on the screen, cards are respectively dealt to the player and dealer). As a result, a win/lose (any of a player's win, a dealer's win and a draw) is judged based on the hand of cards thus handed out and the results of the judgment are then transmitted to each player's terminal 4. Next, each player's terminal 4 increases or decreases the accumulated credit based on the win/lose results thus received from the main control portion 31.

The main control portion 31 controls output of an image signal to be displayed on the front display 21 and driving of the speaker 22 and LED 23.

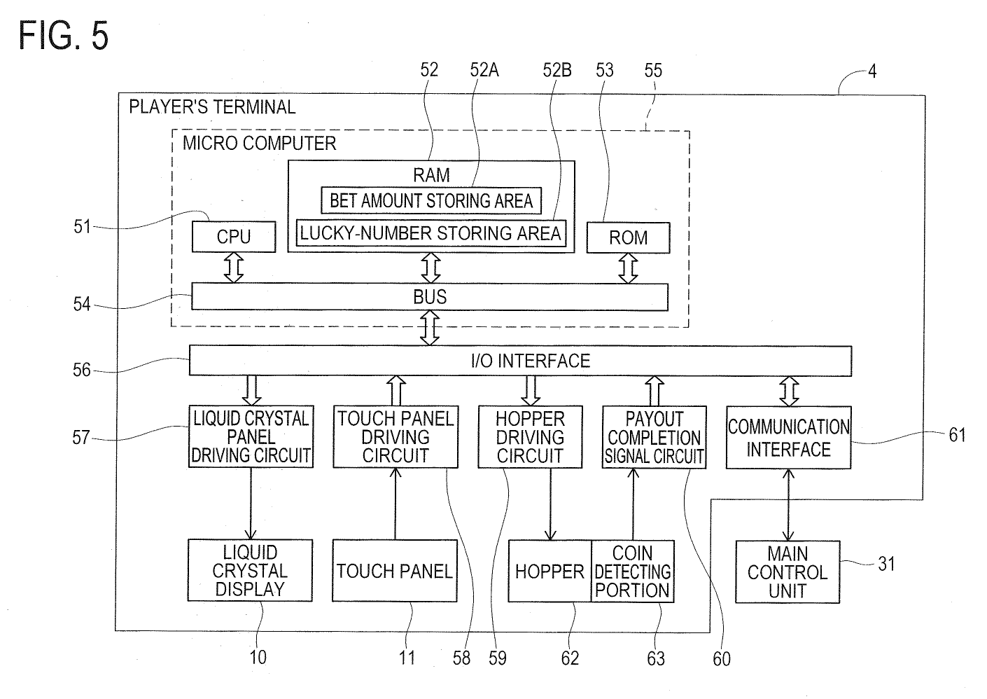

Next, a configuration of a control system in the player's terminal 4 will now be described based on FIG. 5. FIG. 5 is a block diagram schematically showing a control system of the player's terminal 4 according to the present embodiment.

As shown in FIG. 5, the player's terminal 4 according to the present embodiment is constituted around a microcomputer 55 which in turn is basically constituted of a CPU 51, a RAM 52, a ROM 53 and a bus 54 for data transfer amongst these components. Data tables and a variety of programs and the like for carrying out processes required for the control in the player's terminal 4 are stored in the ROM 53. The RAM 52 serves to temporarily store a variety of data which is computed in the CPU 51. In addition, the RAM 52 also stores the credit amount currently accumulated in the player's terminal 4, the object of the bet that was placed by the player and the bet amount (credit amount) that was bet as the object of the bet. The RAM 52 has a bet amount storing area 52A and a lucky number storing area 52B. The bet amount storing area 52A stores the bet amount that was bet by the player. The lucky number storing area 52B stores the lucky numbers which are currently set.

The CPU 51 is connected to a liquid crystal panel driving circuit 57, a touch panel driving circuit 58, a hopper driving circuit 59, a payout completion signal circuit 60 and a communication interface 61 through an I/O interface 56. Further, the liquid crystal panel driving circuit 57 is connected to a liquid crystal display 10, the touch panel driving circuit 58 is connected to the touch panel 11, the hopper driving circuit 59 is connected to the hopper 62 and the payout completion signal circuit 60 is connected to the coin detecting portion 63, respectively.

The CPU 51 calculates the bet amount (credit amount) on which the player has placed a bet based on the operation information outputted from the touch panel 11. Then, the CPU 51 stores the bet amount in the bet amount storing area 52A of the RAM 52, while simultaneously transmitting the bet amount to the main control portion 31. Further, the accumulated credit is increased or decreased in accordance with the win/lose result transmitted from the main control portion 31. The CPU 51 also carries out an operation of setting the lucky numbers based on the operation of a user in a one game unit or a plurality of games unit. Further, the CPU 51 calculates the total value of the numbers on the two cards that were initially dealt to the player. Thereafter, the CPU 51 judges whether the total value thus calculated equals any of the lucky numbers he/she wishes to store in the lucky number storing area 42A.

The CPU 51 controls output of the image signal which is displayed on the front display 21 and coin payout from a coin payout port 15 by a hopper 62 and a coin detecting portion 63.

Next, a description will be given on the bet screen 70 which is displayed on the liquid crystal display 10 in the player's terminal 4 in the event of a Blackjack in the gaming machine 1 according to the present embodiment.

FIG. 1 and FIG. 6 are views showing the bet screen 70 which is displayed on the liquid crystal display 10 in the player's terminal 4. In the gaming machine 1 according to the present embodiment, the player carries out a bet operation to bet a credit of a predetermined value using the bet screen 70 and the touch panel 11. The player can also carry out an operation to request an additional card in hand and an operation to increase or decrease a bet amount.

As shown in FIG. 1 and FIG. 6, the bet screen 70 is constituted of a player's card display area 71, a chip display area 73, a lucky number display area 74 and an information display area. The player's card display area 71 displays an image 87 of the card which is dealt to the player. The chip display area 73 displays an image 72 of the chips that were bet. The lucky number display area 74 displays the lucky numbers which are currently set. The information display area displays a variety of operation buttons and player's information.

Here, the player's card display area 71 serves to display an image 87 of the cards which were dealt to the player. Image 87 of a plurality of cards which is displayed on the player's card display area 71 corresponds to the cards which were dealt to the player that seats at the player's terminal 4 and is playing a game.

The chip display area 73 displays a chip image 72 corresponding to a bet amount that the player has bet (for instance, the player has placed a bet on chips corresponding to 50 credits in FIG. 1 and FIG. 6). Before the game starts, the player selects a bet amount by means of the bet button 75 that will be described later. The player enters the bet amount by touching the chip display area 73. The bet amount thus entered is then transmitted to the main control portion 31. Further, if the total value of the numbers on the two cards that were initially dealt to the player equals any of the lucky numbers which are currently displayed on the lucky number display area 74, the player can select an additional bet amount by means of the bet button 75. The additional bet amount thus selected is transmitted to the main control portion 31.

The lucky number display area 74 shows the lucky numbers which are currently set in the gaming machine 1. Here, in the gaming machine 1 according to the present embodiment, the lucky numbers are randomly set in a one game unit or a plurality of games unit based on a player's operation. If the total of the numbers on the two cards which were initially dealt to the player equals any of the lucky numbers which are currently displayed on the lucky number display portion 24, the player is granted the right to place an additional bet by doubling down.

A plurality of bet buttons 75 (corresponding to “1 credit”, “10 credits”, “100 credits” in the present embodiment) are provided at a right lower side of the chip display area 73. The player can select a bet amount to be bet in the current game by touching the bet buttons 75.

A Repeat bet button 76 and an UNDO bet button 77 are provided at an upper portion of the bet button 75. The player can bet a bet amount which is the same as in the previous game, by touching the Repeat bet button 76. A bet operation which was already carried out can be cancelled by touching the UNDO bet button 77.

On the other hand, an operation button group that a player uses to bargain with the dealer are displayed at a left lower side of the chip display area 73. More specifically, a STAND button 78, a HIT button, a SURRENDER button 80, an INSURANCE button 81 and a SPLIT button 82 are provided as operation buttons.

Here, the STAND button 78 is used when the player challenges the dealer using the cards he/she currently possesses, without requesting any more cards. The HIT button 79 is used when the player requests a new card, in addition to the cards he/she currently possesses. The HIT button 79 can also be used until the total of the numbers displayed on the cards that were dealt reaches or exceeds “21”.

The SURRENDER button 80 is used when the player quits the current game. Once the SURRENDER button 80 is selected, half of the bet amount is collected and the other half is returned to the player. The INSURANCE button 81 is used when the player takes an insurance for protection in case a cards that was dealt to the dealer is a Blackjack.

The SPLIT button 82 is used if the numbers displayed on the two cards that were dealt to him/her in the game are the same and he/she splits the cards into two hands. When the SPLIT button 82 is selected, the player can challenge the dealer with a hand of two or more pairs of cards.

A HELP button 84 is provided at a lower side of the STAND button 78. The HELP button 84 is used to display an operation method of the gaming machine 1 on the liquid crystal display 10. A message area 85 for displaying a message that supports the progress of the game is provided at a right side of the HELP button 84.

A lucky number selection portion 95 which is used by the player to select the lucky numbers before the game starts is displayed at a left side of the player's card display area 71 as shown in FIG. 1. A plurality of numerical values (in FIG. 1, “7” through “15”) which can be selected are positioned as lucky numbers on the lucky number selection portion 95.

The player selects a numerical value, which will be selected as a lucky number, from a plurality of numerical values displayed on the lucky number selection portion 95, by using the touch panel 11. Also, the player can randomly select the number of lucky numbers to be selected. Accordingly, in the example shown in FIG. 1, three lucky numbers including “9”, “10” and “11” are selected. Alternatively, two lucky numbers including “12” and “13” alone may be selected, for instance, or, five lucky numbers including “7” through “11” may be selected. The more numerical values are selected as lucky numbers, the lower the maximum gaming value on which an additional bet can be placed. For instance, if three lucky numbers are selected, the maximum gaming value on which an additional bet can be placed is the same as that for the bet amount at the start of the game. If two lucky numbers are selected, the maximum gaming value on which an additional bet can be placed is “the bet amount at the start of the game” ×1.5. If five lucky numbers are selected, the maximum gaming value on which an additional bet can be placed is “the bet amount at the start of the game” ×0.5.

If the right to place an additional bet has been granted to the player, an additional bet selection portion 96 including a selection as to whether to double down or not is displayed at a left side on the player's card display area 71 as shown in FIG. 6. If the player selects to double down through the selection displayed on the additional bet selection portion 96, he/she can place an additional bet. On the other hand, if the player selects not to double down, he/she selects the bet amount and continues to playing the game.

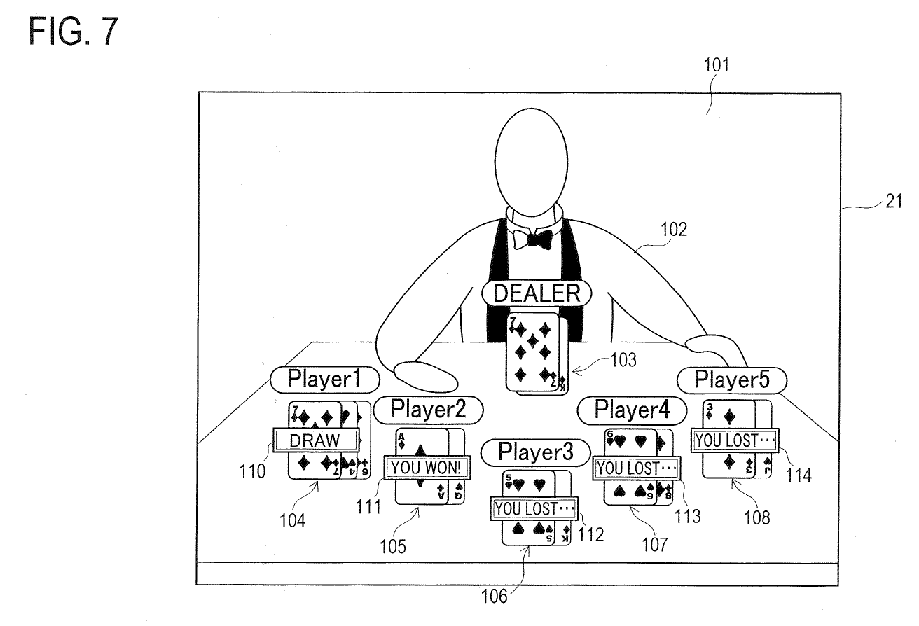

Next, the main screen 101 which is displayed on the front display 21 in the event of a Blackjack in the gaming machine 1 according to the present embodiment will now be described using FIG. 7. FIG. 7 is a view showing the main screen 101 which is displayed on the front display 21. Here, to enhance the sense of realism of the game in the gaming machine 1 according to the present embodiment, the main display 101 displays the image 102 of a dealer that deals cards and the like through animation, in accordance with the progress of the game on the main screen 101.

The image 103 of the card showing a card which is dealt to the dealer is displayed substantially at the center of the main screen 101. Further, card's images 104 through 108 showing cards which were dealt to each player (maximum five players) that play a game in each player's terminal 4 and win/lose result images 110 through 114 showing a win/lose between each player and the dealer are shown at a lower side of the main screen 101. A player can reference the main screen 101 to find out the type of the cards that were dealt to the dealer, the type of the cards that were dealt to the other players that play the game at the same time, their own win/lose results and at the same time, the win/lose results of the other players.

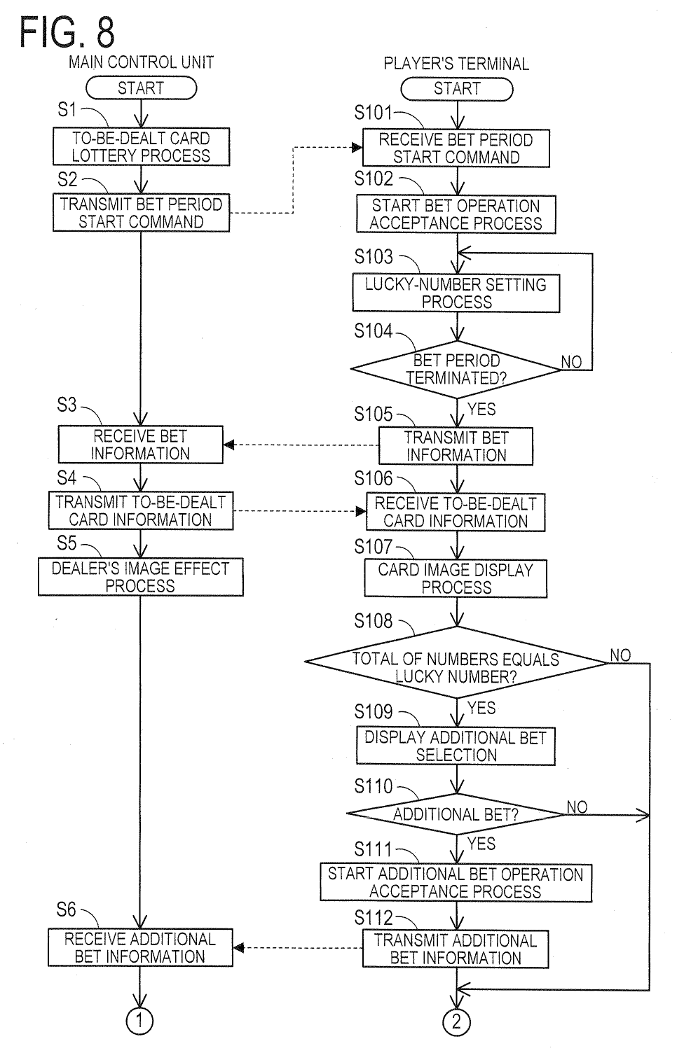

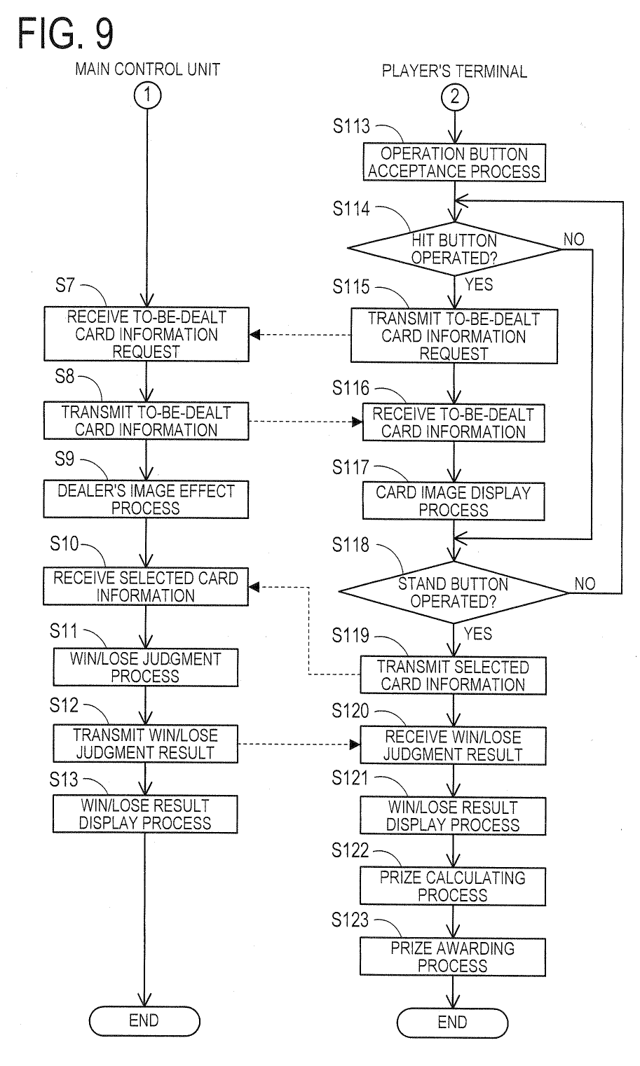

Next, a description will be given on the game process program to be executed by the CPU 41 of the main control portion 31 and a game process program on the player's terminal side which is to be executed by the CPU 51 of the player's terminal 4 in the gaming machine 1 according to the present embodiment and having the above configuration, based on FIG. 8 and FIG. 9. The programs which are shown by flow charts in FIG. 8 and FIG. 9 are stored in the RAM 42 and ROM 43 provided in the main control portion 31, or the RAM 52 and ROM 53 provided in the player's terminal 4 and are executed by the CPU 41 and the CPU 51.

First, the game process program to be executed by the main control portion 31 will be described based on FIG. 8 and FIG. 9. At step (hereinafter abbreviated as S) 1, the CPU 41 executes a to-be-dealt card lottery process in which cards which will be handed out to the player and the dealer will be drawn. More specifically, supposing a number of N cards (in Blackjack, N=52) are used in one game, any of the numbers from 1 to N (dealing sequence) will be associated with each card, respectively. The cards are handed out to the dealer and players in accordance with this sequence (e.g., the cards are dealt to the dealer and players).

Thereafter, at S2, CPU 41 transmits a bet period start command in which a player's bet operation is transmitted with respect to each player's terminal 4.

Next, at S3, the CPU 41 receives the bet information which was transmitted from each player's terminal 4. Here, the bet information includes information with respect to the bet amount (credit amount) on which a bet was placed by the player. The bet information received at each player's terminal 4 is once stored in the RAM 42.

Next, at S4, the CPU 41 transmits information (for instance, “the 7 of hearts”, “the A of spades”, etc.) with respect to the first card and the second card which will be handed out (dealt) to the players that play a game at the player's terminals 4, to each player's terminal 4.

Thereafter, at S5, the image of the dealer that deals two cards to each player and the dealer is displayed on the front display 21 as the main screen 101 (refer to FIG. 7). The mark type of the two cards which were dealt to the dealer is not displayed when the cards are dealt.

Next, at S6, the CPU 41 receives additional bet information which is transmitted from each player's terminal 4. Here, the additional bet information includes information with respect to the bet amount (credit amount) on which an additional bet is placed by the player. The additional bet information received at each player's terminal 4 is once stored in the RAM 42 together with the bet information received at S4.

Next, at S7, the CPU 41 receives a request for a new to-be-dealt card which was transmitted from the player's terminal. The information with respect to a third card and other subsequent cards is transmitted to the player's terminal 4 from which the request is made, in accordance with the request (S8). Further, at S9, the image of the dealer that will deal the additional card to the player that made the request is displayed on the front display 21 as the main screen 101.

Then, at S10, the CPU 41 receives selected card information which is transmitted from each player's terminal 4. The selected card information is transmitted when the player has selected to challenge the dealer with the cards he/she has at present. The selected card information is transmitted to the main control portion 31 when the STAND button 78 has been selected in the player's terminal 4 as will be described later.

Then, at S11, the CPU 41 compares the hand with the cards that were handed out to the player to the hand with the cards that were handed out to the dealer and makes a win/lose judgment. More specifically, the hand with the total of the numbers displayed on the card being closest to “21”, without exceeding “21” is judged to be the winner. If the sum is the same, it is judged that a draw has occurred.

Next, at S12, the win/lose judgment results at S11 will be transmitted to each player's terminal 4. At S13, the CPU 41 displays the win/lose result images 110 through 114 showing the win/lose judgment results at each player's terminal 4 on the main screen 101 of the front display 21 (refer to FIG. 7). Then, the game process program is terminated.

A description will now be given on the game process program to be executed in the player's terminal 4 based on FIG. 8 and FIG. 9. At S101, the CPU 51 receives a bet period start command from the main control portion 31 before the game starts.

Thereafter, at S102, the CPU 51 starts the bet operation acceptance process and displays the bet screen 70 (refer to FIG. 6) onto the liquid crystal display 10. Then, the CPU 51 identifies the bet amount (credit amount) that has been bet based on the operation information received from the touch panel 11.

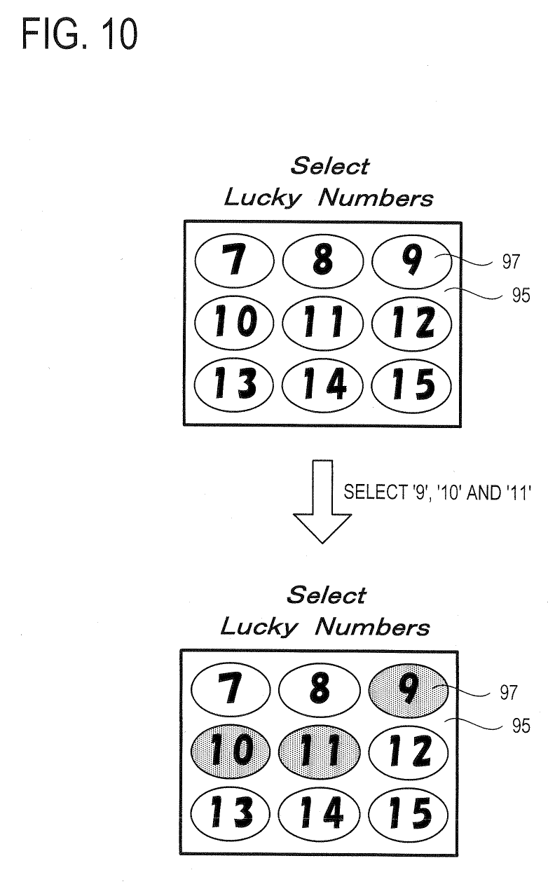

Further, at S103, the CPU 51 carries out a lucky number setting process in which the lucky numbers are set based on the player's operation. The lucky number setting process at step SI may be carried out in a one game unit, or alternatively, it may be carried out in a plurality of games unit (for instance, every five games). A specific example of the lucky number setting process to be executed at step S1 will now be described in detail using FIG. 10.

After executing the lucky number setting process (S103), the CPU 51 first displays the lucky number selection portion 95 on the bet screen 70 as is shown in FIG. 1. Here, FIG. 10 shows a lucky number selection sequence using the lucky number selection portion 95. The lucky number selection portion 95 includes numeric buttons 97 which have nine numerical values from “7” through “15” respectively displayed as shown in FIG. 10. A player touches a numeric button 97, from amongst the “7” to “15” numeric buttons 97, having the numerical value that he/she wishes to set as a lucky number. Alternatively, the CPU 51 identifies the numeric button 97 that the player has touched using the detection results of the touch panel 11 and then sets the numerical value corresponding to that numeric button 97 as lucky number. As a result, the display color of the numeric button 97 with the numerical value set as the lucky number will change. If the player touches the same numeric button 97 once again, the CPU 51 removes the numerical value corresponding to the numeric button 97 that was touched from the lucky numbers. The lucky number thus selected is stored in the lucky number storing area 52B of the RAM 52.

Next, at S104, the CPU 51 judges whether the bet period has been terminated or not. More specifically, at S102, the CPU 51 judges whether a certain period (for instance, 20 sec) set in advance has lapsed since the start of the bet operation acceptance period.

If it is judged that the bet period has not been terminated (S104: NO), the CPU 51 accepts the bet operation. Alternatively, if it is judged that the bet period has been terminated (S104: YES), the flow shifts to S105.

At S105, the CPU 51 transmits bet information with respect to the main control portion 31. Here, the bet information includes information with respect to the bet amount (credit amount) bet by the player in the bet operation acceptance process that started at S102. The lucky numbers set at S103 are transmitted to the main control portion 31 as well.

At S106, the CPU 51 receives information (mark type), from the main control portion 31, on the first and second cards that were handed out to the player that plays a game at the player's terminal 4 in question. At S107, the CPU 51 displays the cards that were handed out on the bet screen 70 based on the card information received at S106.

Thereafter, at S108, the CPU 51 judges whether the total of the numbers associated with the two cards displayed at S107, e.g., the two cards that were initially dealt to the player, equals any of the lucky numbers that were set at S103.

If it is judged that the total of the numbers associated with the two cards that were initially dealt to the player equals the lucky numbers (S108: YES), the flow shifts to S109. Alternatively, if it is judged that the total of the numbers associated with the two cards that were initially dealt to the player does not equal the lucky numbers (S108: NO), the flow shifts to S113.

At S109, the CPU 51 displays a selection of whether to place an additional bet by doubling down at the left side of the player's card display area 71 in the bet screen 70 (refer to FIG. 6). Then, at S110, the CPU 51 judges whether the player has selected to place an additional bet based on the operation information received from the touch panel 11.

If it is judged that the player has selected to place an additional bet (S110: YES), the flow shifts to S111. On the other hand, if it is judged that the player has selected not to place an additional bet (S110: NO), the flow shifts to S113.

At step S111, the CPU 51 starts the acceptance process of an additional bet operation and then identifies the bet amount (credit amount) on which an additional bet was placed based on the operation information from the touch panel 11. The maximum gaming value on which an additional bet can be placed is set based on the bet amount before the additional bet is placed and the number of numerical values which were set as lucky numbers at step S103.

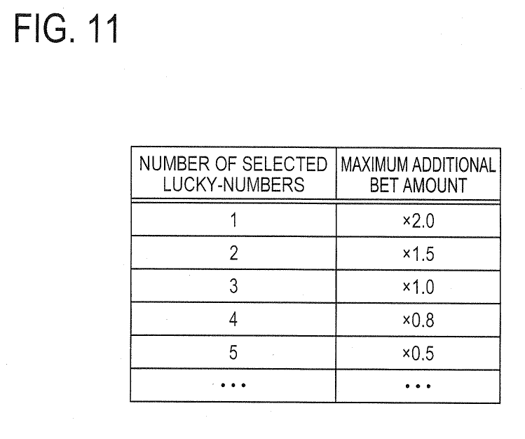

For example, as shown in FIG. 11, if only one lucky number is set, the maximum gaming value on which an additional bet can be placed becomes “the bet amount at the start of the game” ×2.0. If two lucky numbers are set, the maximum gaming value on which an additional bet can be placed becomes “the bet amount at the start of the game” ×1.5. If three lucky numbers are set, the maximum gaming value on which an additional bet can be placed is the same as the bet amount at the start of the game. If four lucky numbers are set, the maximum gaming value on which an additional bet can be placed becomes “the bet amount at the start of the game” ×0.8. If five lucky numbers are set, the maximum gaming value on which an additional bet can be placed becomes “the bet amount at the start of the game” ×0.5.

Next, at S112, the CPU 51 transmits additional bet information with respect to the main control portion 31. Here, the additional bet information includes information with respect to the bet amount (credit amount) on which an additional bet was placed by the player.

Then, at S113, the CPU 51 starts reception of the operation of the respective buttons 78 through 81 which are displayed on the bet screen 70. At S113, in particular, it is judged whether the HIT button 79 was selected. If it is judged that the HIT button 79 was selected (S114: YES), the CPU 51 transmits a request to the main control portion 31 for an additional card to be dealt (S115). Next, at S116, the CPU 51 receives card information that was newly transmitted from the main control portion 31 and displays the card that was newly handed out on the bet screen 70 based on the card information thus received (S117). If the player carries out an additional bet operation at S111 by doubling down, he/she can request only one new card to be dealt.

On the other hand, if it is judged that the HIT button 79 has not been selected (S114: NO), the flow shifts to S118.

At S118, it is determined whether the STAND button 78 has been selected or not. If it is judged that the STAND button 78 has been selected (S118: YES), the CPU 51 transmits a notice to the main control portion 31 that a selection was made to challenge with the cards which are currently displayed (S119). Alternatively, if it judged that the STAND button 78 has not been selected (S118: NO), the flow returns to S114. If the other operation buttons 80 through 84 have been selected, a process in accordance with the selected button will be carried out.

Next, at S120, the CPU 51 receives the win/lose judgment results transmitted from the main control portion 31. Then, at S121, the CPU 51 displays on the liquid crystal display 10 the win/lose judgment results of the player that played a game at the player's terminal based on the win/lose judgment results transmitted at S120. More specifically, the characters “DRAW” are displayed on the bet screen 70 in the event of a draw. Also, the characters “YOU WON” are displayed in case the player has won. Furthermore, the characters “YOU LOST” are displayed in case the player has lost.

Next, at S122, the CPU 51 calculates the prize to be awarded to the player based on the total bet amount obtained by adding up the bet amount accepted at S102 and the additional bet amount accepted at S110, and the win/lose judgment results. Then, at S122, the CPU 51 awards the prize calculated at S121 to the player. More specifically, if the player has won to the dealer, he/she is awarded twice the credit of the total bet amount. If the player reached a draw with the dealer, he/she is awarded a credit corresponding to the total bet amount.

As was described in the above text, in the gaming machine 1 according to the present embodiment, one or a plurality of lucky numbers are set in a one game unit or a plurality of games unit based on a player's operation prior to the start of the game (S103). Then, if it is judged that the total value of the numbers on the two cards which were initially dealt to the player equals the lucky numbers, a selection as to whether to place an additional bet is displayed on the liquid crystal display 10 (S109). If the player has selected to place an additional bet, an additional bet operation is accepted (S111) and a prize is awarded based on the total bet amount obtained by adding the bet amount to the bet amount that was placed prior to the start of the game (S123). Thus, the gaming machine judges whether the right to place the additional bet should be granted based on the total value of the numbers on the cards that were dealt to the player and the numerical values that were selected by the player in advance. Accordingly, the conditions for placing the additional bet can be newly set to conditions desired by the player, thereby offering new attraction to the player.

The present invention is not limited to the above-described embodiment and various modifications and alterations can be made thereto without departing from the scope of the present invention.

For instance, in the present embodiment, the lucky numbers are set based on the selection of the player at each player's terminal 4. However, one type of lucky numbers may also be set for the entire gaming machine. In this case, for instance, the gaming machine 1 selects one player by lottery from a plurality of players during the game. The lucky numbers selected by the player that was chosen by lottery are set as the lucky numbers for the entire gaming machine 1.

In the present embodiment, the right to place an additional bet is granted if the total of the numbers on the two cards that were initially dealt to the player equals the lucky numbers. However, the right to place an additional bet may also be granted if the number on either of the two cards that were initially dealt to the player equals the lucky numbers. The right for the additional bet may also be granted if the combination of the two cards that were initially dealt to the player is a combination selected by the player (for instance, the case in which the two cards have the same number or the case in which the two cards have the same suit).

The gaming machine according to the present invention can be applied to a gaming machine in which a card game such as Pai Gow Poker and Draw Poker, in addition to Blackjack is played. For instance, in case of Pai Gow Poker, the right to an additional bet by raising is granted if the total value of the seven cards that were dealt to the player equals the numerical value selected by the player.

The present invention can also be realized as a gaming method for executing the above-described processes. Furthermore, the invention can also be realized as a program that causes execution of the gaming method on a computer, and a recording medium onto which this program has been recorded.

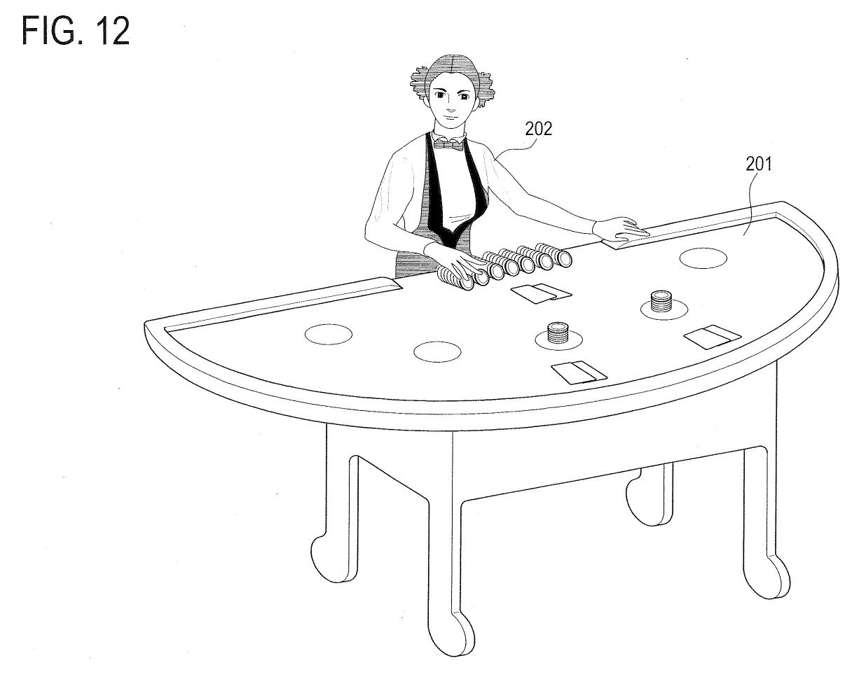

The gaming method in the gaming machine according to the present invention can also be applied to Blackjack (the so-called table game) which is played by a dealer 202 and a player (not shown) on a gaming table as shown in FIG. 12.

In the table game shown in FIG. 12, the dealer 202 deals the respective cards to the dealer and player on the gaming table 201. The player then places a bet by placing chips at a predetermined location on the gaming table 201.

If the total of the numbers on the two cards that were initially dealt to the player equals the numerical value declared by the player before the game starts, the player can place an additional bet by doubling down.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A gaming machine comprising:
a display that displays a plurality of cards;
an operation portion that accepts input information from a player;
a bet operation portion that enables input of a player's bet operation for a player's entry to a game; and
a processor which executes:
(a) a process of causing the player to select one or a plurality of card combinations based on operation of the operation portion;
(b) a process of accepting the player's bet operation based on operation of the bet operation portion;
(c) a process of displaying a predetermined number of cards dealt to the player on the display; and
(d) a process of accepting an additional bet operation if a card combination displayed on the display equals a card combination selected by the player.

2. A gaming machine comprising:
a display that displays a plurality of cards, each card having a number associated therewith;
an operation portion that accepts an input operation from a player;
a bet operation portion that enables input of a player's bet operation for a player's entry to a game; and
a processor which executes:
(a) a process of causing the player to select one or a plurality of numerical values based on operation of the operation portion;
(b) a process of accepting the player's bet operation based on operation of the bet operation portion;
(c) a process of displaying a predetermined number of cards that were dealt to the player on the display; and
(d) a process of accepting an additional bet operation if a total value of numbers associated with the cards displayed on the display equals a numerical value selected by the player.

3. A gaming machine comprising:
a display that displays a plurality of cards, each having a number associated therewith;
an operation portion that accepts input information from a player;
a bet operation portion that enables input of a player's bet operation for the player's entry to a game; and
a processor which executes:
(a) a process of causing the player to select one or a plurality of numerical numbers based on operation of the operation portion before the game starts;
(b) a process of accepting the player's bet operation based on an operation of the bet operation portion;
(c) a process of displaying a predetermined number of cards that were dealt to the player on the display; and
(d) a process of accepting an additional bet operation if a total value of numbers associated with the cards displayed on the display equals a numerical value selected by the player.

4. The gaming machine of claim 3, wherein the processor executes the process (a) in a one game unit or a plurality of games unit.
